(19) United States
(12) Patent Application Publication
(10) Pub. No.: US 2015/0178784 A1
(43) Pub. Date: Jun. 25, 2015

(54) Lead Generation Tool

(71) Applicant: See Inside, Inc., Dallas, TX (US)

(72) Inventors: Christopher Oliver, Dallas, TX (US); PJ Putnam, Dallas, TX (US); Dawn Meifert, Schenectady, NY (US); Amy Anderson, Allen, TX (US)

(21) Appl. No.: 14/578,108

(22) Filed: Dec. 19, 2014

Related U.S. Application Data
(60) Provisional application No. 61/919,348, filed on Dec. 20, 2013.

(51) Int. Cl. G06Q 30/02

(52) U.S. Cl. CPC G06Q 30/0267; G06Q 30/0277

(57) ABSTRACT

Disclosed herein are techniques for a Lead Generation Tool that create a passive entity, such as a QR code or NFC tag associated with a promotion, and that generate a prepopulated message on a user's communications device when it is scanned, read, or otherwise input to activate the passive entity. As used herein, a “passive entity” is defined to include images, codes, tags, or any other unique identifiers that may be encoded with uniquely identifying information and codes. The term “activating” is defined to include either an action by a user that scans, reads, or otherwise inputs the unique information contained in the passive entity into a device operated by the user or the mere presence of a user near a passive entity while equipped with a passive entity receiver, which will input the unique information contained in the passive entity into a device operated by the user. After activating the passive entity, the user is only required to tap SEND to respond to the promotion.

### RELATED APPLICATION

The present disclosure is a non-provisional conversion of, and thus claims priority to, U.S. Provisional Patent Application No. 61/919,348, filed Dec. 20, 2013, the entirety of which is hereby incorporated herein by reference for all purposes.

### TECHNICAL FIELD

The present disclosure is generally related to techniques for responding to promotions, and more particularly to systems and methods for creating a passive entity associated with a promotion that generate a prepopulated message on a user's communications device when it is scanned or read.

### BACKGROUND

The use of passive entities or identifiers by businesses as a means of presenting promotions for their products and services has historically helped those businesses expand consumer awareness and boost sales. Currently, passive entities (e.g., QR codes, Near-Field Communication (NFC) tags, Radio Frequency Identification (RFID) tags, Short Message Service (SMS) messages, and such similar entities) are used on promotional displays and items as a means to navigate a consumer to a particular place in the digital world, for example to navigate the consumer to a website via a browser on the consumer's communications device. In these situations, a person typically takes an action to activate such a passive entity, and such action creates a simple “one-way trip” for the person to a digital location designed/created by the business having the promotion. In addition, the business that created that passive entity may not even know that anyone has taken an action towards activating one of their passive entities.

Additionally, some businesses employ a lead capture system that requires users to manually type in a message and text it to a specific receiving number or short code, which is also manually typed by the user. This conventional technique is in use by a number of businesses for lead capturing; however, this approach is typically cumbersome and prone to errors, often due to typographical errors by the consumers. Even in situations where businesses can detect that consumers have activated a passive entity, that detection is typically limited to logging a simple “activity” count, that is, how many times the passive entity was activated and possibly a timestamp of when each such activation occurred. As a result, those businesses have only passed along some information to each user, but the businesses have not acquired any contact information (e.g., telephone number) from the persons who activated the passive entities, and which may be used for targeted advertisements or other two-way interaction with responding consumers.

With regard to SMS-based techniques for responding to merchant promotions, current methods of SMS marketing require consumers to take action in response to a sign, a radio or TV message, or to print media by sending a specific SMS message to a specific number or short code. This technique requires a user to correctly type both the destination number or short code, as well as the specific verbiage in the body of the SMS message before the message can be sent successfully. Without typing both the destination number and message body correctly, the action by the user will have no effect. Moreover, the precision of the verbiage in the message body is also important because many different promotions often share the same destination numbers with only the message body differentiating them.

Accordingly, what is needed in the art is a technique for responding to promotions involving passive entities, such as SMS message-based responses that is more streamlined than, and alleviates the potential errors found in, conventional techniques. Additionally, what is needed is a technique that logs responding consumer contact information for use in both targeted marketing efforts and to track future consumer interactions resulting from the initial response to the passive entity. The disclosed principles provide such a solution.

### SUMMARY

Disclosed herein are systems and related methods of a Lead Generation Tool that create a passive entity, such as a QR code or NFC tag associated with a promotion, and that generate a prepopulated message on a user's communications device when the passive entity is scanned, read, or information therefrom is otherwise input to activate the passive entity. As used herein, a “passive entity” is defined to include images, codes, tags, or any other unique identifiers that may be encoded with uniquely identifying information. As used herein, the term “activating” is defined to include either an action by a user that scans, reads, or otherwise inputs the unique information contained in the passive entity into a device operated by the user or the mere presence of a user near a passive entity while equipped with a passive entity receiver, which will input the unique information contained in the passive entity into a device operated by the user. After activating the passive entity, the user is only required to tap SEND to respond to the promotion. In an embodiment, when the user scans the passive entity, a message is automatically generated to the user that encourages the user to tap SEND to obtain something that may be of value to the user.

Once the user sends the message, the response message and user information are routed to a web-based or network-based application, that can include cloud-based applications. The network-based application can then log the consumer's response and associated contact information, and provide a response message containing promotional information to the user. For example, in one embodiment, when the disclosed principles create an SMS message in response to scanning a passive entity, the user simply sends the message to the destination phone number or short code specified in the prepopulated text message. The message body, user's phone number (or other identifying information of the user and/or his device), and destination phone number or short code specified in the prepopulated text message, as well as a unique identifier associated with the promoted item of value, are routed via a communications network, such as the Internet, to the network-based application for processing. The application captures the user's response to the promotion and contact information (e.g., phone number), and a SMS message response with the promotional reward or other information can then be returned to the user.

Moreover, in addition to acquiring the date & time of the user's activation, a business can obtain the telephone number that activated the passive entity and, therefrom, the user's name and address. Meaningful communication between the person and the business can then take place by text message, phone call, mail, or other means derived from knowledge of the mobile phone number acquired when the user responds to the promotion in the disclosed manner. Using the Lead Generation Tool, a person opts-in when the passive entity is activated with a response to the promotion, and the user is rewarded for such activation. By encoding the passive entity with the destination number/short code used for a response, and automatically populating a response message with this information, the disclosed principles provide for accurate communication of responses to promotion by eliminating potential typographical errors. Additionally, the disclosed principles streamline the response process by simply requiring only two actions by the user: the scan or other means of activating the passive entity, and the action of sending the prepopulated message generated by the activation of the passive entity.

### BRIEF DESCRIPTION OF THE DRAWINGS

Exemplary embodiments of the disclosed principles are described herein with reference to the following drawings, in which like numerals identify similar components, and in which:

FIG. 1 illustrates one embodiment of an exemplary QR code containing text strings and other information used to generate a response communication by scanning the QR code in accordance with the disclosed principles;

FIG. 2 illustrates one embodiment of an exemplary SMS application having the prepopulated message appear on the screen of a communications device in accordance with the disclosed principles;

FIG. 3 illustrates one embodiment of an exemplary process by which a QR code containing a prepopulated text message and destination telephone number or short code for use in responding to a promotion may be generated in accordance with the disclosed principles;

FIG. 4 illustrates one embodiment of an exemplary process of a user responding to a promotion employing a QR code in accordance with the disclosed principles;

FIG. 5 illustrates one embodiment of an exemplary process for providing a promotional reward to a user via a response message, in accordance with the disclosed principles;

FIG. 6 illustrates one embodiment of an exemplary process for accessing a reward webpage using a link provided in a response message, in accordance with the disclosed principles;

FIG. 7 illustrates a broad overview of an exemplary process of a user employing a message pre-population technique in accordance with the disclosed principles;

FIG. 8 illustrates a more specific embodiment of an exemplary process of employing a QR code for a message pre-population technique in accordance with the disclosed principles;

FIG. 9 illustrates a continuation of the exemplary process flow introduced in FIG. 8;

FIG. 10 illustrates a continuation of the exemplary process flow introduced in FIGS. 8 through 9;

FIG. 11 illustrates a continuation of the exemplary process flow introduced in FIGS. 8 through 10; and

FIG. 12 illustrates a continuation of the exemplary process flow introduced in FIGS. 8 through 11.

### DETAILED DESCRIPTION

As introduced above, the disclosed principles provide a streamlined technique for users to respond to a promotion by only requiring the user to scan, read, or otherwise activate a passive entity created for the particular promotion, and then sending a prepopulated message generated by the activation of the passive entity using the user's device. The disclosed principles can employ any type of response medium when activating a passive entity. For example, instead of generating a prepopulated SMS message on a user's communications device used to scan the passive entity, the disclosed principles may alternatively cause a prepopulated email to be generated via the communications device. Of course, other types of prepopulated communications media may also be provided by the disclosed principles when the passive entity is activated. In such embodiments, the consumer identifier associated with the prepopulated communication medium can be used to log the consumer's information for later interaction with, or tracking activity by, the consumer. Furthermore, the disclosed principles may be extended to any future replacement for consumer identifiers like telephone numbers should the traditional phone number be replaced with something else.

Moreover, any number and type of passive entity, either now existing or later developed, may be employed with the disclosed principles. For example, QR codes utilize an open-standard and thus the need for a proprietary application to be installed on a user's communications device is negated. Thus, this type of passive entity provides a “cross platform” solution and utilizes a common, ubiquitous application or feature available on any type of communications device in the form of a “QR Code Reader.” Also, NFC tags may be employed as passive entities, which employ wireless signals, such as an RFID signal, rather than a visual recognition pattern to provide the encoded data discussed herein. Furthermore, passive entities may also be employed, if desired. For example, Microsoft® Tags may be employed, which operates in the same manner as a QR code, albeit proprietary to Microsoft Tag reader applications or devices. Similarly, Image Recognition Encoding may also be employed with the disclosed principles, which also operates in the same manner as a QR code, albeit proprietary to specific mobile applications.

Still further, the promotional information associated with a promotion presented with the disclosed principles is not limited to any particular type of promotion. For example, the promotional information provided to a user (i.e., a reply message) in response to his response to a passive entity as disclosed herein could be some form of reward. Such rewards could be in the form of a virtual tour for a real estate promotion (e.g., via a link provided in the reply message), coupons or discount codes delivered to the user either by response message or a later time, instant-win game chances, sweepstakes entries, milestones in augmented reality games and/or marketing promotions, videos, digital gifts, instant connection to tech support and customer service, registration of a purchased product, etc. In short, any type of promotional information may be provided to consumers in response to their activation of a passive entity in accordance with the disclosed principles.

To further understand how the disclosed principles provide the above-mentioned advantages in promotional situations, multiple exemplary embodiments are discussed below. A first exemplary embodiment employs a QR code as the passive entity and a user's communications device is used to activate the QR code to automatically generate an SMS message response for the promotion. More specifically, a system or method in accordance with the disclosed principles creates a QR code that contains a destination number, such as a telephone number or short code, as well as a pre-written text message. The pre-written message could provide an instruction for the user to simply press send to receive a promotional item or other item of value. Thus, when the QR code is scanned by the user's communications device, the information provided by the QR code opens the SMS client on the communications device used to scan the QR code. In addition, the “To” field (e.g., message header) of the text or other type of message is automatically prepopulated with the destination number, and the “Message Body” field is automatically populated with the necessary response verbiage or information specified in the QR code. Both the message header and body information may be derived from the passive entity, using the scanning or other technique for gathering information from the passive entity.

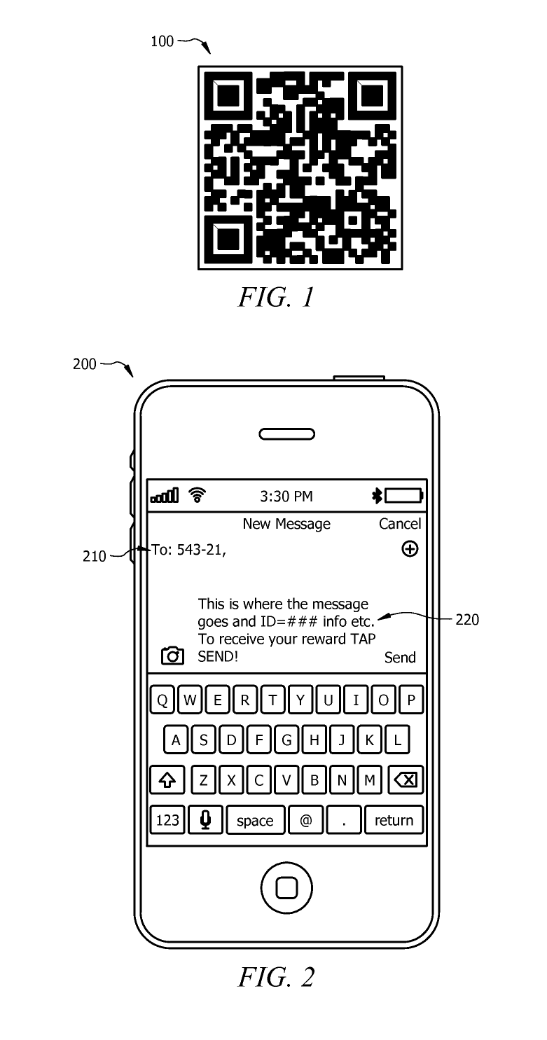

An exemplary QR code containing text strings and other information used to generate a response communication by scanning the QR code 100 is illustrated in FIG. 1, and an exemplary screen shot 200 of a communications device's SMS application having the prepopulated message is illustrated in FIG. 2. Exemplary text strings (210, 220) that may be encoded into a QR code and automatically populated into a device's SMS client via simply scanning the QR code 100 are set forth below:
smsto: 543-21: This is where the message goes and ID=### info etc. To receive your reward TAP SEND!

Message Body: This is the location on the user's communications device's screen where the message is displayed and ID=### info etc. To receive your reward TAP SEND!

By scanning the QR code 100, the pre-coded message body 220 and destination number or short code 210 will populate the user's screen 200 using the device's SMS application. Once the scan of the QR code 100 is complete (which takes less than a second), the user's only action required is to press or tap “Send.”

The prepopulated text message 220 can also contain unique identifiers such as promotional identifiers and/or specific keywords that can be extracted by the network application to determine promotional information (e.g., reward information), and the location where the scanning interaction took place (by virtue of using a unique identifier within the message field of the QR code 100) allowing for location tracking Importantly, both of these are provided by the disclosed principles without the need for an application to be installed on the user's communications device, and without the need for the User to “ALLOW LOCATION SERVICES” within an application or on the device in general. Moreover, the unique identifier, which has been previously associated with the item of value that is the subject of the promotion, may be included in any part of the message, and it may be visible to the user or not visible, and instead embedded within the prepopulated message. This is also the case with any other information being transmitted using the prepopulated message, such as the user identification information, the “To” address of the message, or any other information.

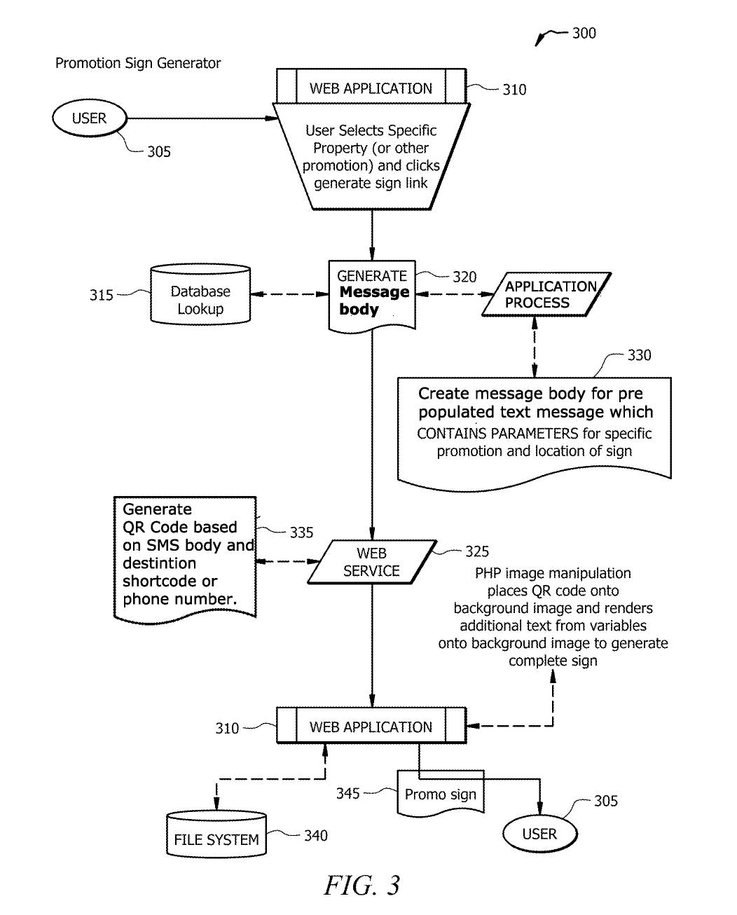

FIG. 3 illustrates an exemplary process 300 for generating a QR code (e.g., a passive entity as used herein) containing a prepopulated text message for use in responding to a promotion in accordance with the disclosed principles. In this illustrated process, the “user” 305 is considered the person or organization creating the QR code for use with a promotion associated with a particular property, such as real property offered for sale, and thus information regarding the real property would be an item of value to a user as provided herein. Thus, the “user” in this aspect may be a merchant, advertiser, distributor, etc. of the item of value. As shown, the user 305 may employ a web application 310 implemented as disclosed herein to generate the unique QR code by selecting the property to be promoted, and then electing to generate a sign link (i.e., a sign comprising a passive entity and a unique identifier associated with an item of value). A “web application” as used herein is a software application executed via a web server that uses tools like databases and server-side scripting programming languages, such as PHP or ASP.Net, to deliver experiences beyond the standard web page or web form for clients using web browsers. In the embodiments discussed herein, the web application 310 may be implemented by a distinct entity offering the disclosed principles as a service to merchants, advertisers, and marketers of property, goods, and services.

The web application 310 employs a database 315 used for storing the properties or other items that may be the subject of a promotion. In addition, the database 315 may store the specific unique identifier for the property to be promoted by the QR code's generated text message body 320. Once the specific property and identifying information are retrieved from the database 315 or otherwise determined, the web application 310 may then generate a text message body 330 that will be used in the process of generating the QR code.

Once a text message body is created, if applicable, the web application 310 also engages the web service 325 to generate the unique QR code 335. In such embodiments, the web service 325 is an independent service employed for creating such unique signs embedded with selected information. Thus, in these embodiments, a “web service” is a specialized service that allows software developers to, for example, programmatically generate graphic images such as QR Codes, make and receive phone calls and send and receive text messages using its web service APIs. Other types of messages may also be employed. Examples of the web service 325 include, but are not limited to, Google Charts. Twilio, Ribbit, Jaduka, Skype, Cloudvox, Tropo, Teleku, QuickFuse, Bitly, etc. (Any trademarks used herein are the property of their respective owners). In other embodiments, the web application 310 may be configured to generate the QR code 335 itself. In either embodiment, in accordance with the disclosed principles, the unique QR code 335 (or other generated sign/passive entity) is created. More specifically, the generated sign is embedded with the destination address (e.g., short code, phone number, etc.), as well as message body data for use in prepopulating a response message in a consumer's device when the QR code 335 is scanned. For example, destination information (e.g., an address for use in the header of a message) and predetermined text or other information for the body of the response message are encoded into the generated sign/passive entity. Accordingly, when a consumer scans, reads, or otherwise inputs the generated sign, or gathers information from the sign, via his communication device, the encoded data is used to automatically activate the device's message application, and to create (and prepolutate) a new message (e.g., a text message) on the consumer's device with the destination and body information prepopulated so that all the consumer need to do is send the automatically generated message. The body portion of the message may also contain instructions to the consumer to press send to receive an award, promotional item, or other item that may be of value to the consumer.

Once the unique QR code or other type of sign is generated by the web service 325, if employed to do so, the unique sign is returned to the web application 310. The web application 310 may then be used to create advertisements or other promotional presentation information that includes the unique sign. Such promotional presentation of the unique passive entity may include any type of electronic visual media (television, radio, satellite, Internet, etc.), billboards, signs, and consumer product labels. For example, background images related to the property being promoted may be retrieved from storage and the unique sign incorporated into the imagery. Once the web application 310 has finished configuring the unique QR code or other sign with any desired imagery (e.g., stored in a file system 340) or other promotional information, the completed promotional document(s) 345 with the unique sign may then be provided to the user 305. The user 305 may then use the completed promotional document(s) 345 in promoting the property for sale, such as posting the promotional document(s) 345 on a virtual or physical sign promoting the property. Potential consumers can then easily scan the unique QR code with a communications device, and then simply click-to-send the automatically generated prepopulated response message in order to gain additional information on the property.

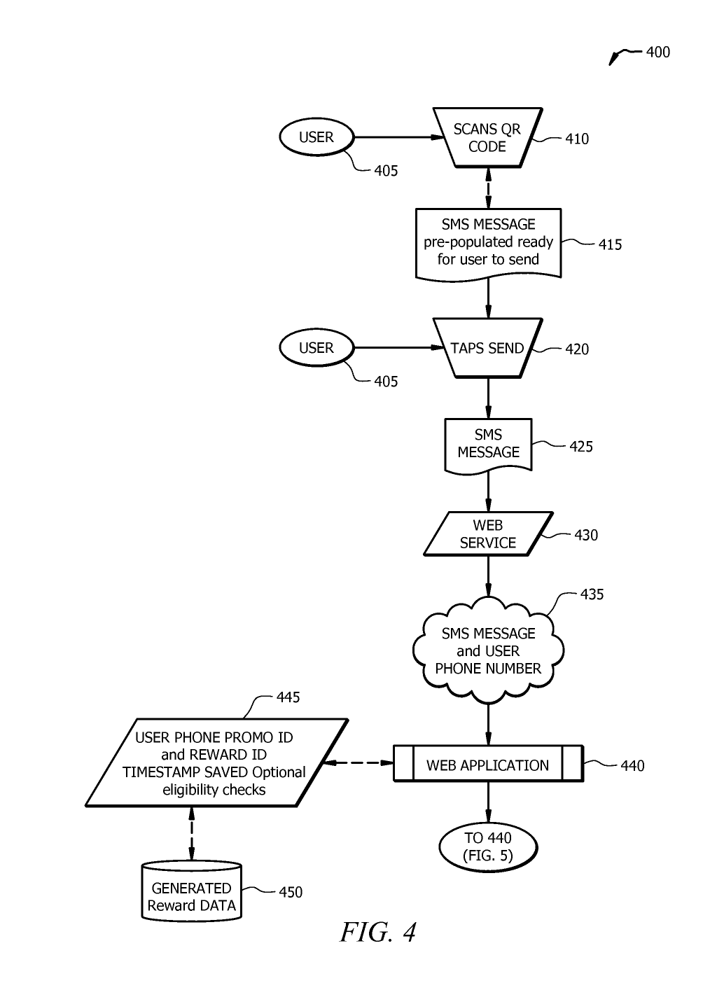

Looking now at FIG. 4, illustrated is an exemplary process 400 of a user 405 responding to a promotion employing a QR code in accordance with the disclosed principles. In this aspect, the “user” may be a consumer of the item of value. Specifically, a QR code is initially created, for example, in accordance with the process discussed above, for a particular promotion. As discussed in detail above, the QR code contains a message and destination number that will automatically activate and prepopulate the SMS application on the user's communications device as a ready-to-send SMS text message in response to the scanning of the QR code. Also, however, this example of a QR code is merely illustrative and any type of passive entity created as disclosed herein may also be created.

The QR code, which is associated with a particular promotion (e.g., via a unique identifier), may then be placed on or near the item being promoted or a location where a user/consumer can find the promotional information. For example, a non-exhaustive list of the places where such a QR code could be placed includes a fixed geographical location (e.g., a sign or billboard); a moving location (e.g., the side of a bus, a taxi, or even an airplane); on a business card, brochure, magazine, newspaper, video screen, broadcast TV or Internet transmission; an article of clothing; and even as a temporary tattoo on a person (e.g., a model in a store or on the product/fashion runway). Accordingly, there is no limitation where or how the QR code or other passive entity created as disclosed herein may be located for consumers to find it.

A user 405 then finds and scans 410 the QR code using a generic QR code reader on the user's communications device. On scanning the QR code, the user's SMS application is automatically opened, and a new message initiated, in response to the scanning. Also, the encoded information in the QR code is used to automatically populate 415 the message body and destination phone number/short code in the new ready-to-send text message. In addition, the unique identifier is also included in the message. The prepopulated text message to be sent may also include instructions for the user to TAP SEND. Once the user 405 taps SEND 420, the message is sent to the destination number that is pre-coded inside the QR code and was automatically populated in the message.

In this embodiment, the destination number or code is “hosted” at a web service 430 that interfaces with the mobile data and telephone network. Accordingly, the web service 430 may be configured to send the information 435 received via SMS message from the user 405 to an affiliated web application 440. For example, this may be accomplished by performing a FORM POST action to a destination URL for a web application code page. The information 435 from the text message that is sent to the web application 440 may include: the user's phone number, the receiving number (i.e., the destination short code number or phone number), the date and time of the scan (e.g., a timestamp when web service receives the message from the user 405 who scanned the QR code), and the body of the prepopulated message. As discussed above, the body of the message 425 may contain unique identifiers, such as characters, numbers, words, ID numbers, or codes, which may be extracted using string manipulation and conditional logic by the web application 440. Such unique identifiers may then be stored 445 in variables in memory, and used in database queries and conditional logic to identify the promotion, reward, location, etc. of the QR code sign, and to update scan metrics that allow for sorting on the QR code that was scanned, at what time and date each was scanned, and by what communications device's identification information (i.e., phone number). The generated reward data may then be stored in a rewards database 450.

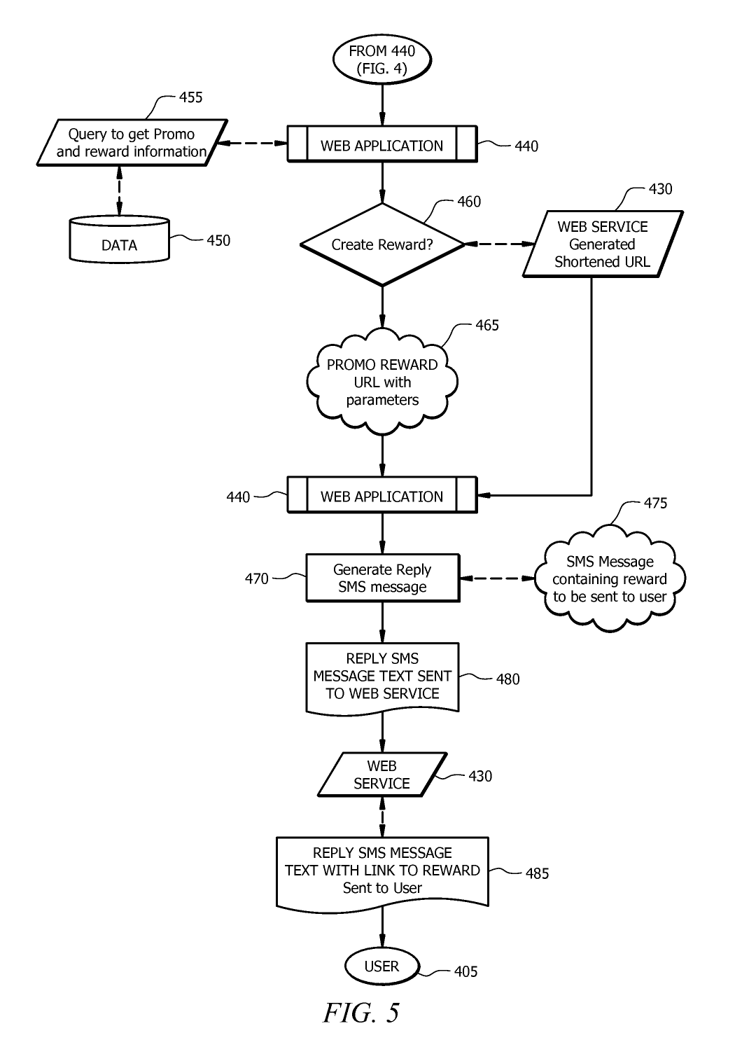

Moving on to FIG. 5, illustrated is an exemplary process 500 for providing a promotional reward to a user 405 via a response message, in accordance with the disclosed principles. The web application 440 queries or otherwise accesses 445 the reward database 450 to obtain the promotion/reward information stored therein, and then creates the reward 460 for the user 405. Specifically, trackable reward hyperlinks containing query string variables (including user's phone number, promo ID, and token) (i.e., URL with parameters) 465 are generated by the web application 440. The hyperlinks may also be “shortened” (which is advantageous when communication media having limited character numbers, such as SMS messages, are employed) by using API calls to a URL shortening service 470. Whether shortened or not, this URL becomes part of the response message body to be returned to the user by the web application 440 via a reply message 475 to the user's device.

To generate the response message 470, 475, an API call is made to the web service 430 and the return message body, user's phone number, and return sender number (phone network short code number or phone number) are passed 480 to the web service 430 for processing of the reward response message 475. When the web service 430 receives the API call, the web service 430 formats and sends 485 the SMS reward response message 475 to the user's device that scanned the QR code or other passive entity. The user 405 is then alerted that he has received an incoming SMS message.

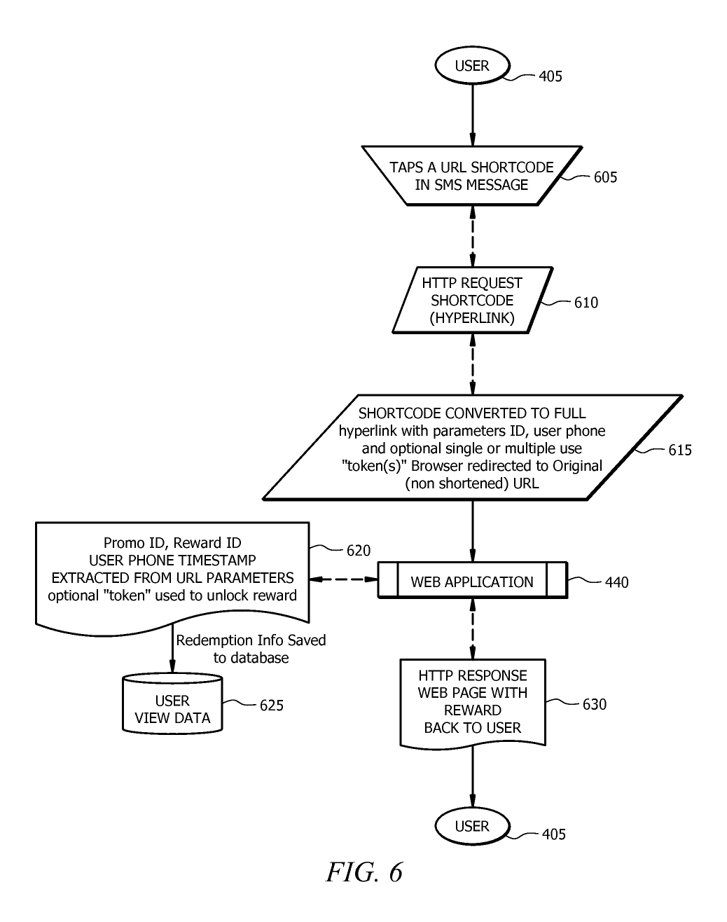

Turning now to FIG. 6, illustrated is an exemplary process 600 for accessing a reward webpage using a link provided in a response message, in accordance with the disclosed principles. Once the response message 475 prompted by the user's 405 sending of the initial prepopulated message is received at the user's device, the user 405 can now interact with the message by tapping 605 a link included in the response message 475. For example, the link 610 may comprise a shortened URL that leads to/generates the reward, a tap-to-call link, a URL leading to a webpage with a chat feature, a URL to a web contact form, or that opens an email message with a send-to address or other information.

In the illustrated embodiment, the link 610 in the response message 475 comprises a shortened URL link. When the user taps 605 that reward link 610 in the response message 475, a browser is automatically opened 615 by the communications device and a request is sent to the URL. For the shortened URL, the URL shortening service translates the shortened URL to its original parameterized query string URL, and redirects the browser to that URL, which then leads to a processing code page within the web application. The parameters including the user's phone number, promotional ID, and token may then be extracted utilizing query string GET functionality and placed into variables for use in generating the reward, database queries, metrics, etc.

The web application 440 will log the time of the reward request by checking 620 the system clock, and that information combined with the promo ID, token, and user's phone number can be saved to the database 625 for metrics purposes and reporting. In this embodiment, the parameters relevant to generating the reward are used in database queries and conditional logic to generate or redirect the browser to the reward page. At this time, the token may be marked as “used” if this is a one-use promo. Also, optionally, a check can also be performed using the user's phone number to confirm eligibility (see FIG. 4, 445) for the reward. Once any pre-designated conditions are met, the user's browser is redirected to the reward URL 630. This redirection may also include a single use token. The token can be generated and added as a parameter to the query string in the URL leading to the reward webpage. It can then be extracted and used to “mark as used” the specific token.

Through the utilization of APIs that provide reverse phone number lookup services (e.g., freecnam.org, whitepages.com, etc.), the user's communications device's identification number (i.e., phone number) that was obtained from when the user scanned the QR code and sent the original message can be used to acquire additional information about the user 405. For example, the disclosed principles may be able to determine the name and address of the owner of the mobile communications device that scanned the QR code and sent the original message. Other applications or services may also be employed to discover additional information about the user, such as the user's email address, home phone number, social media usernames, etc. (collectively, referred to herein as “additional information”). This additional information can then be added to the database along with the time/date, location, specific promotion the user 405 responded to, and any reward information provided in response to the user's scan/message.

At the same time that the web application receives the additional information, an optional “USE TOKEN” can also be generated, as mentioned above. This USE TOKEN can later be added as a parameter in the reward URL that will be sent back to the user via a response message. The optional use of a token will ensure that a given reward is only accessed once for every scan. Of course, other means for limiting such reward access may also be employed. In addition, in such an exemplary embodiment, it is possible to limit a reward to a specific mobile number based on a chronological frequency (that is, once per mobile number per minute, per hour, per day, etc.) regardless of the number of times that a user utilizes his communications device to scan any specific QR code. With certainty, a system or method in accordance with the disclosed principles can register and limit the specific number of scans by the same user using the same communications device scanning the same QR code because the communications device's phone number has been acquired during each scan and saved into the database, and a database association is made between that specific QR code or other passive entity providing an identifier within the prepopulated message body.

Benefits provided by the unique and novel Lead Generation Tool include shortening the amount of typing needed to respond to a promotion by implementing a simple two-step process of scanning, reading, or otherwise activating a passive entity affiliated with the promotion, and then sending a message or other communications medium automatically generated and prepopulated when the passive entity was activated. A system as disclosed herein can also acquire the telephone number and other additional contact or identifying information of the user. Such information can then be used to communicate with the user regarding the original promotion or any other promotions. The disclosed principles also allow for locational advertising without requiring users to enable “Location Services” on their communications device. For example, a response SMS text message can be sent to the user's communications device with a specific promotion based on the specific location of the original scan.

The disclosed principles also provide streamlined entry into sweepstakes and other giveaways or contest. More specifically, users can quickly create an entry with their necessary personal information by simply activating a passive entity encoded with the proper information as disclosed herein to automatically generate an entry for the user to simply send in. The disclosed principles can further provide a mechanism to authenticate a user and optionally limit the number of entries into sweepstakes and giveaways, or simply the number of times the user responds to a specific promotion. For example, using the disclosed principles a client-company can truly enforce its number of entries per timeframe (day/week/month/etc.) policy by tying sweepstakes entries to a particular phone number or other user communication medium. In other embodiments, the disclosed principles can also provide a mechanism where a user can play augmented reality games based on scanning passive entities and interacting with the messages returned. Such “real world” games may be played through a user making incremental steps at specific geographical locations, or even within departments in a single geographic location. Direct feedback is provided to the user on his progress in the game.

Still further, the disclosed principles may even be implemented via dynamic media, such as an image during a television program (either as part of the broadcast or via an interactive television device), or images on a movie projection screen, or Internet transmissions. In another embodiment, the disclosed principles may be employed with a QR code related to the promotion of a real estate property for sale. Of course, as discussed above, various passive entities other than a QR code may be employed, as can other communications means from the user activating the passive entity. In sum, the disclosed principles may be implemented via virtually any type of media capable of displaying or otherwise presenting a passive entity to consumers, where that passive entity is encoded with promotional information and that when activated by the user, causes a message with prepopulated destination address and body information to be generated for the user to simply send via his device.

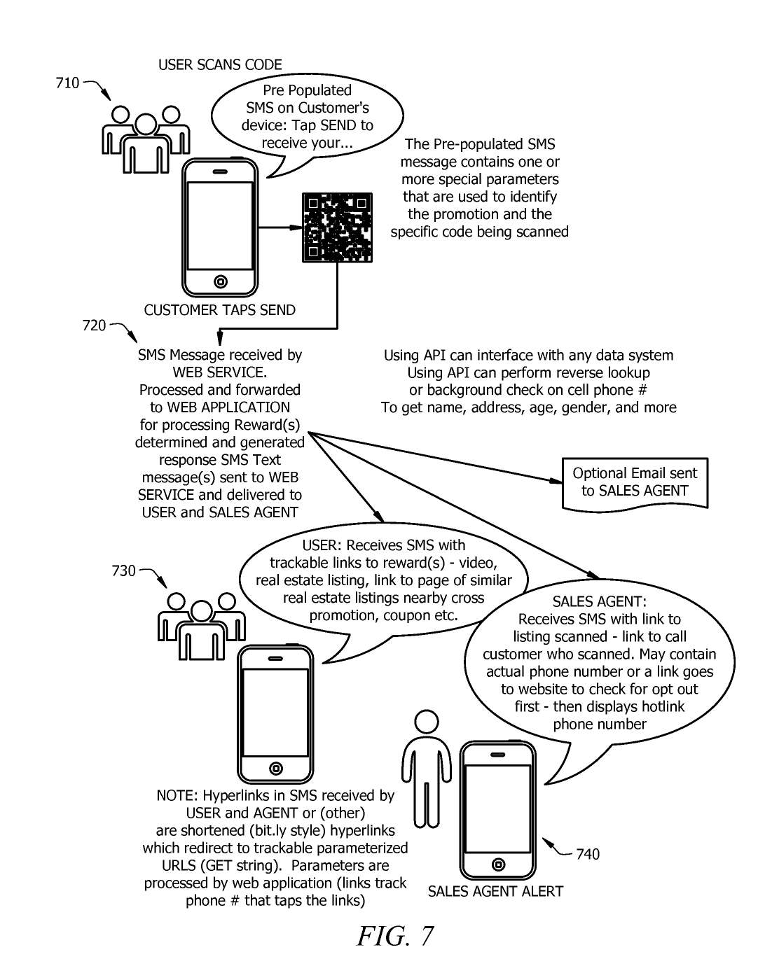

FIG. 7 illustrates a broad overview of an exemplary process 700 of a user employing a QR code in accordance with the disclosed principles. The general process 700 begins at a step 710 with a user scanning a QR code (or other image, etc.) and sending the prepopulated SMS text message. The SMS text message is automatically generated and per-populated as described in detail above, and the user then sends the message at a step.

At a step 720, the SMS text message is received by the web service and sent to the web application. The web application may query a reverse lookup or perform a background check on the user's phone number to acquire detailed information about the user. The web application generates and sends to the user, at a step 730, a reply SMS text message including reward(s) and the message is sent to the web service and delivered to the user's communications device. At a step 740, the web application may also generate a SMS text message and deliver it to an agent of the distributors (here, a Sales Agent) using the same method providing a sales lead to the Sales Agent. Optionally, the lead may also be delivered by email or any other type of communication. The delivery email address is based on the specific code and promotion scanned, similar to the technique used of the reply SMS message discussed above.

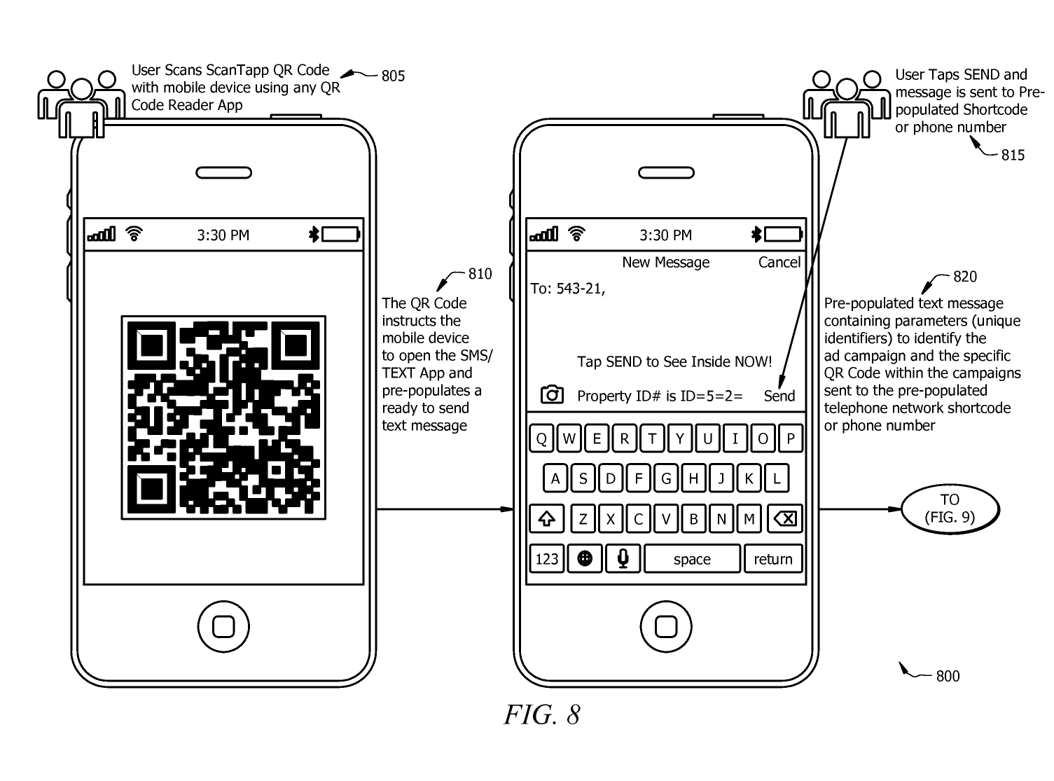

FIG. 8 illustrates a more specific embodiment of an exemplary process 800 of employing a QR code for a message pre-population technique in accordance with the disclosed principles. At step 805, the process begins with a user scanning a QR code, which then, at step 810 automatically opens the user's SMS text messaging application on the user's communications device, and then pre-populates a ready to send text message. Both the message and the destination phone number or shortcode are prepopulated automatically and the message is ready for the user to send. In addition, a unique identifier code associated with the item of value is also illustrated as part of the message body, and which was also derived from the scanned QR code. The unique identifier code may include one or more special characters for use by the receiving web application, web service, or other system component. Such special character(s), which in the illustrated embodiment is an equal sign, may be used by the underlying components of the system to determine what part of the message body is the unique identifier. Such a special character may also be used to indicate divisions between portions of the unique identifier code, where each part of the code may indicate something different to the system receiving the message from the user. Such a special character would typically be unintelligible to the user with respect to its meaning, such as the equal sign employed in FIG. 8.

At step 815, the user sends the automatically generated message. At step 820, the sent message, which contains parameters to specifically identify the specific promotion and specific code the passive entity (in this example a QR code) represents, is received by the web service.

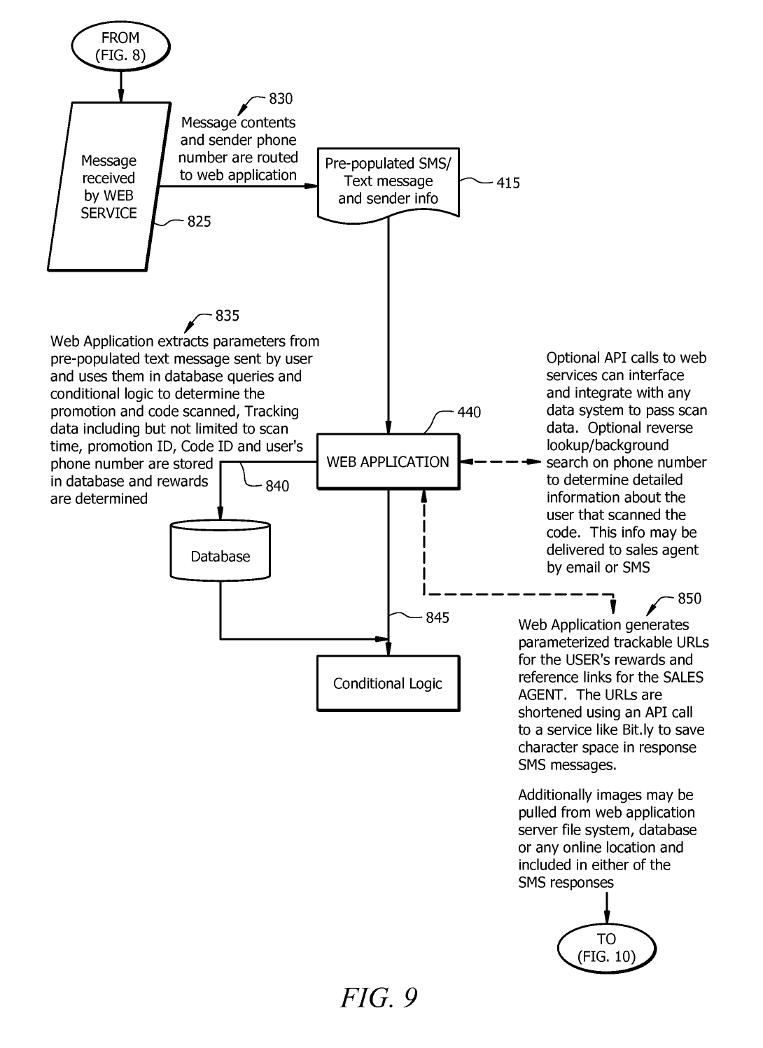

FIG. 9 illustrates a continuation of the exemplary process flow 800 introduced in FIG. 8. At a step 825 whereby the web service receives the prepopulated text message 415 sent by the user and passes the message 514, at a step 830, and the user's communications device's identification number (i.e., phone number) to the web application 440. The web application 440 may perform API calls to gather additional information about the user through third party services (e.g., reverse lookup or background check services). At a step 835, the web application 440 extracts the parameters from the body of the message 415 to determine the specific promotion and reward information for the specific interaction. Database checks 840 and conditional logic 845 may be applied to retrieve reward information, determine reward eligibility (such as eligibility for a sweepstakes entry) or current status for a player or participant in an augmented reality game or scavenger hunt promotion. In addition, the web application 440, at a step 850, generates parameterized trackable URLs for the user's rewards and reference links for the sales agent. The URLs may be shortened as described above using an API call to service, such as Bit.ly to save character space in response messages. The shortened URLs may then be added to the response short message service text message to the user. Optionally images may be imbedded within the short message service text message such as digital coupons, product images, diagrams, specifications or other digital images.

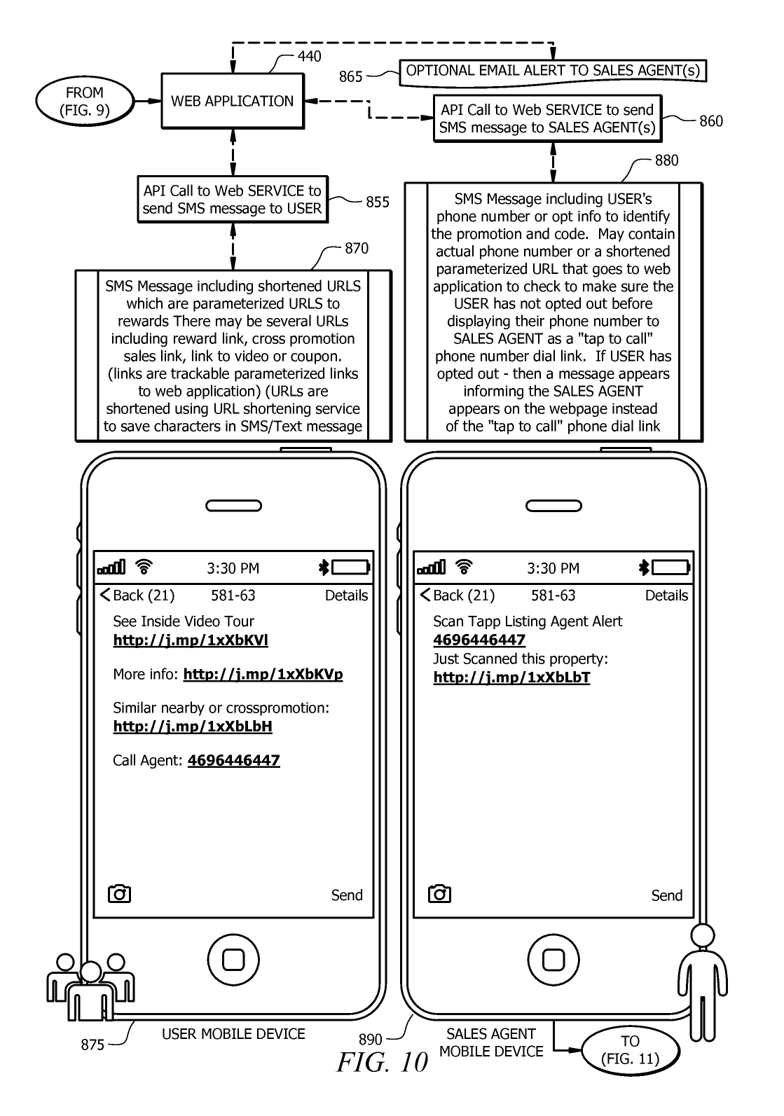

FIG. 10 illustrates a continuation of the exemplary process flow introduced in FIGS. 8 and 9. At this stage of the exemplary process, the web application 440 may be configured to make API calls to the web service to deliver the response message containing reward(s) to the user (step 855), and API calls to the web service to deliver a sales lead message to the sales agent (step 860). The user message 870 may be received on the user's device 875, while the agent's message 880, may be received on the agent's device 885. Optionally, at step 865, sales agent may also receive an email notification.

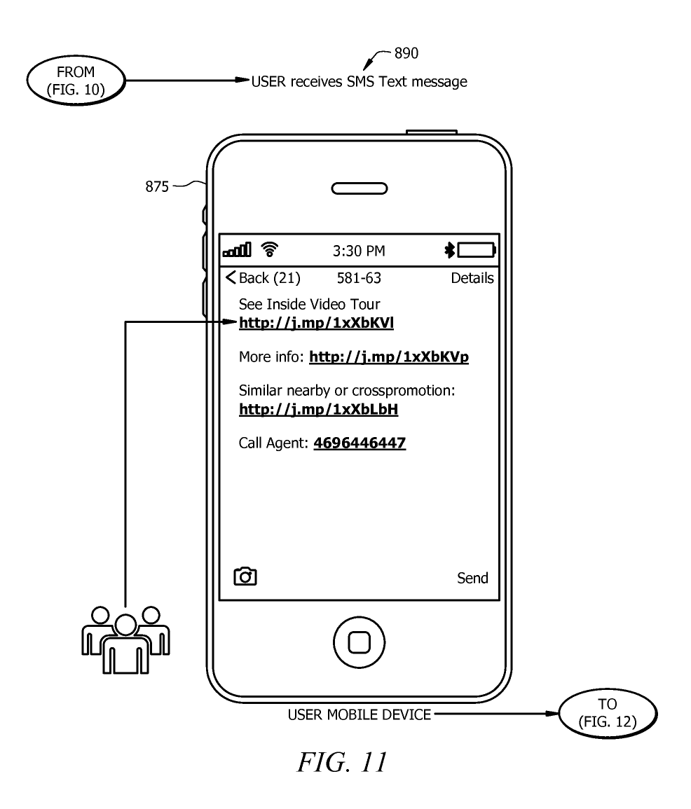

FIG. 11 illustrates a continuation of the exemplary process flow 800 introduced in FIGS. 8 through 10. FIG. 10 illustrates an embodiment where the user receives the response message, at a step 890, and then the user interacts with the response message by tapping shortened URL links to redeem rewards. In this embodiment, the user interacts with the received message by tapping shortened hyperlinks to receive rewards or direct dial sales agent(s) or direct dial and auto navigate through a call tree system. The tap-to-call phone number in the text message may be delivered as a tapable number within the text message as illustrated in FIG. 11, and may contain pauses and digit dial navigation of a call tree to directly reach any extension in a phone system. Multiple pauses and digits allow for any deep navigation within a call tree system. Optionally, a shortened parameterized hyperlink may be substituted. This would lead to a dynamic web page displaying the tap to call phone number. This additional step allows for a dynamic system of routing to different sales agents.

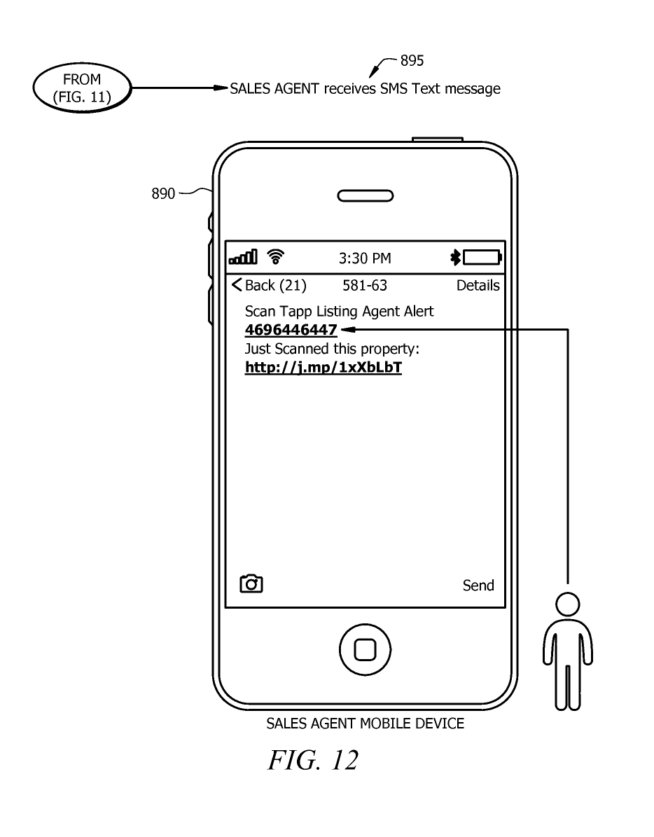

FIG. 12 illustrates a continuation of the exemplary process flow introduced in FIGS. 8 through 11. FIG. 12 illustrates an embodiment whereby, at step 895, a sales agent interacts with a sales lead alert message received earlier in the process. The sales agent interacts with the sales lead alert message by tapping shortened hyperlinks to retrieve information about promotion scanned if required. The sales agent may receive a direct dial sales agent(s) or direct dial link to call the user that scanned the code. The tap-to-call phone number in the text message may be delivered as a tapable number within the text message, as illustrated in FIG. 12, or optionally a shortened parameterized hyperlink may be substituted. This would lead to a dynamic web page displaying the tap-to-call phone number. This additional step would allow for a user to opt out of being called by sales agents. A user would opt out by sending a STOP message to the telephony shortcode or phone number, and the web application 440 would store data indicating that user is on a “do not call list” for sales agents receiving the sales agent alert.

In accordance with the above discussion, the follow provides non-exhaustive embodiments of systems and methods implementing the principles disclosed herein:

A method for integrating the use of an attached or embedded passive entity on a good or service that when activated by a user will create an electronic link, the method comprising the steps of: creating a passive entity encoded with uniquely identifying information used by the distributor; attaching the passive entity to a good or service intended to be locations for an electronic link between a user and the distributor; offering the particular passive entity to the user by placing the passive entity on particular goods or services; activating the passive entity by the user which will be displayed on the communications device in the form of a brief message to be read by the user; activating the embedded code that lies beneath the brief message read by the user using a short message services text message to open a channel of communications between the user and the distributor; querying the user from the proprietary communication device that activated the passive entity to determine if the user would like to open an electronic link between the user and the distributor; instructing the user to “tap” on the “Send” button on the small message service text that was published on the screen of the user's proprietary communications device to open the electronic link between the user's proprietary communication device and the at least one computer processor of the distributor; receiving first communication from the communications device at the at least one computer processor, the first communication sent by the user after the user's affirmation to open the electronic link between the user and the distributor activating the passive entity published in the particular instance of electronic communications material displayed on the communications device and comprising at least a portion of the data encoded within the embedded passive entity to establish a communications link; transmitting the identification information of the user's the communications device to the memory of the at least one computer processor of the distributor; querying the memory by the at least one computer processor based on the portion of the data encoded in the passive entity to determine the reward to generate; transmitting via a second communication to the screen of the user's the proprietary communications device one or more rewards as determined by the memory by the at least one computer processor based on the portion of the data encoded in the passive entity to determine the reward to generate.

A method in accordance with the above example, wherein the distributor is able to attach or embed a passive entity to electronic media, which includes broadcast and linear visual media, electronic billboards, internet transmissions, and tangible objects, which includes signs (including mobile billboard ads on transportation vehicles), objects, goods, in a manner where a user can activate that passive entity through the use of the user's proprietary communications device to open a channel of communications between the user and the distributor.

A method in accordance with one or more of the above examples, where the activation of the passive entity by the user occurs by the scanning, reading, or otherwise publishing the unique information contained within the passive entity to the screen of the user's proprietary communications device.

A method in accordance with one or more of the above examples, wherein the first communication comprises the identity of the passive entity that was activated by the user and the identity information is used to query the reward information from memory by the at least one computer processor of the distributor.

A method in accordance with one or more of the above examples, wherein the first communication comprises the identity of the propriety communications device that activated the passive entity by the user and the identity information is used to query additional information about the user and save it to the memory by the at least one computer processor of the distributor and send such identifying information to agents of the distributor who can open additional channels of communication between such agents and the user.

A method in accordance with one or more of the above examples, wherein the at least one computer processor queries a third-party database to determine additional information about the user based on the identification information contained within the user's communications device.

A method in accordance with one or more of the above examples, wherein the first communication provides a unique way to establish a communication channel between the distributor and the user tied to the communications device's unique identifying information and the passive entity that the user activated with such communication's device.

A method in accordance with one or more of the above examples, wherein the second communication is transmitted to the communications device.

A method in accordance with one or more of the above examples, wherein the second and subsequent communications may provide one or more rewards to the user that may be in the form of an embedded communication link that will provide additional information to the user regarding the particular service or goods associated with the location of or good or services where passive entity was located or attached.

A method in accordance with one or more of the above examples, wherein the second and subsequent communication may consist of a short message services text message containing additional embedded links to additional rewards or a voice call with an agent of the distributor.

A method in accordance with one or more of the above examples, wherein the second and subsequent communication may contain a one-tap-to-phone dial-link capable of navigating a call tree system by utilizing pauses and automatic dialing of extensions without user action to initiate a voice call with an agent of the distributor.

A method in accordance with one or more of the above examples, wherein the user's contact information is checked against the distributors “Opt-Out List” residing in the memory of the at least one computer processor, and if there is a match, a token will be added next to that user's information that is stored in the memory of the at least one computer processor that will stop the transmission of any contact information associated with the user of the proprietary communications device to an agent of the distributor.

A method in accordance with one or more of the above examples, wherein the user's contact information is sent to a third-party database to determine if the user is listed on a “Do Not Call List,” and if there is a match, a token will be added next to that user's information that is stored in the memory of the at least one computer processor that will stop the transmission of any contact information associated with the user of the proprietary communications device to an agent of the distributor.

A method in accordance with one or more of the above examples, wherein the second and subsequent communications are transmitted to the at least one computer processor of the distributor and sends such identifying information to agents of the distributor.

A method in accordance with one or more of the above examples, where in the second and subsequent communications may contain a traceable, single or multiple use image (e.g., a coupon) that can contain a bar code or other scannable entity that is published on the screen of the user's proprietary communications device that can be used by the user as a reward.

A method in accordance with one or more of the above examples, wherein the at least one computer processor may transmit a second communication that provides the contact information or additional query to the user for additional communication opportunities with the distributor to provide subsequent information on the good or service.

A system for responding to an activation of an attached or embedded passive entity associated with a good or service, the system comprising the instructions encoded by the distributor and embedded within the passive entity; memory used by the distributor of the passive entity; one or more computer processors used by the distributor and configured to: store information on each particular passive entity by the one or more computer processors used by the distributor; download the particular information of the passive entity when it is activated by the user's communications device to the one or more computer processors used by the distributor; store contact information for the distributor of the user's communications device in the memory of the one or more computer processors used by the distributor; receive a first communication sent by the user's communications device in response to the user activating the embedded electronic link published a particular instance of reading material displayed on the screen of the user's communications device, the first communication comprising at least a portion of the data encoded within the attached or embedded passive entity; query the memory based on the portion of the data encoded in the attached or embedded passive entity to determine the reward associated with such passive entity; query the memory based on the first communication to obtain contact information of the user's communications device; cause a second communication to be sent to the user which will provide the user with an electronic link containing the reward associated with the particular passive device and provide additional options for the user to communicate with the distributor.

A system in accordance with the above example, wherein the one or more computer processors used by the distributor and configured to query 3rd party reverse lookup services based on the unique identifying information contained within the user's communications device.

A system in accordance with one or more of the above examples, wherein the one or more computer processors used by the distributor and configured to publish to the screen of the user's communications device the particular reward associated with the particular embedded or attached passive entity to the user's communications device.

A system in accordance with one or more of the above examples, wherein the distributor is able to attach or embed a passive entity to electronic media, which includes broadcast and linear visual media, internet transmissions, electronic billboards, and tangible objects, which includes signs (including mobile billboard ads on transportation vehicles), objects, goods, in a manner where a user can activate that passive entity through the use of the user's communications device to open a channel of communications between the user and the distributor.

A system in accordance with one or more of the above examples, the passive entity can be attached or embedded electronically in a visual manner includes broadcast whether live or recorded, linear entertainment, and internet transmissions.

A system in accordance with one or more of the above examples, wherein the distributor is able to attach or embed a passive entity to electronic media, which includes broadcast and linear visual media, internet transmissions, electronic billboards, and tangible objects, which includes signs (including mobile billboard ads on transportation vehicles), objects, goods, in a manner where a user can activate that passive entity through the use of the user's communications device to open a channel of communications between the user and the distributor.

A system in accordance with one or more of the above examples, wherein the one or more computer processors used by the distributor and configured to store additional information about the user, gained from the 3rd party reverse look up service.

A system in accordance with one or more of the above examples, wherein the one or more computer processors used by the distributor after the distributor acquires the contact information of the user's communications device, query a 3rd party reverse look up service for additional information of the user and send all available information regarding the user to a designated agent of the distributor for subsequent communications.

A system for using a passive entity as a single entry point for a sweepstakes or contest.

A system in accordance with one or more of the above examples, wherein the distributor creates a passive entity encoded with uniquely identifying information used by the distributor.

A system in accordance with one or more of the above examples, wherein the at least one computer processor of the distributor devises the points within a chronological time period associated with the period of the sweepstakes or contest to determine when a token is submitted that exactly matches such time period would be considered an instant win.

A system in accordance with one or more of the above examples, wherein the distributor is able to attach or embed a passive entity to electronic media, which includes broadcast and linear visual media, internet transmissions, electronic billboards, and tangible objects, which includes signs (including mobile billboard ads on transportation vehicles), objects, goods, in a manner where a user can activate that passive entity through the use of the user's communications device to open a channel of communications between the user and the distributor.

A system in accordance with one or more of the above examples, wherein the user activates the passive entity by the user which will be displayed on the screen of the user's communications device in the form of a brief message to be read by the user.

A system in accordance with one or more of the above examples, wherein the user activates the embedded code that lies within the brief message read by the user using a short message services text message to open a channel of communications between the user and the distributor.

A system in accordance with one or more of the above examples, wherein the now activated attached or embedded passive entity associated with a sweepstakes or contest transmits the instructions encoded by the distributor and embedded within the passive entity to the least one computer processor used by the distributor of the passive entity.

A system in accordance with one or more of the above examples, wherein one or more computer processors used by the distributor stores the time and date that the particular passive entity was activated.

A system in accordance with one or more of the above examples, wherein the at least one computer processor of the distributor transmits a communication to the user's communications device to publish the particular information of the activated passive entity to the screen of the user's communications device.

A system in accordance with one or more of the above examples, wherein the at least one computer processor of the distributor will save into the memory of the at least one computer processor the contact information of the user's communications device that activated the passive entity.

A system in accordance with one or more of the above examples, wherein the at least one computer processor of the distributor will create a token in the memory of the at least one computer processor that is associated with the identification information of the user's communications device for each time the unique passive entity is activated by that same identification information.

A system in accordance with one or more of the above examples, wherein the at least one computer processor of the distributor will query the memory of the at least one computer processor of the distributor to determine the number of tokens that the identification information of the user's communications device can obtain based on the number of sweepstakes or contest entries per person allowed by the distributor.

A system in accordance with one or more of the above examples, wherein the at least one computer processor of the distributor will query the memory of the at least one computer processor of the distributor to determine if the time that such token that was submitted matches the time period designated as an instant win.

A system in accordance with one or more of the above examples, wherein the at least one computer processor of the distributor will download the particular reward associated with the sweepstakes or contest plus a message to the user of the communication device regarding its win/loss/expiration of the sweepstakes or contest.

A system in accordance with one or more of the above examples, wherein the contest may be a treasure hunt or a scavenger hunt and the reward is instructions to find the next passive entity that the user needs to locate and activate.

A system in accordance with one or more of the above examples, wherein the memory by the at least one computer processor stores the particular information about the contest or sweepstakes; such instructions will consist of the number of instant win rewards per time period, the number of rewards available to be won over the course of the sweepstakes or contest, the frequency by which a particular identification information may enter the sweepstakes per time period, and the messages that will be published on the screen of the user's communications device stating that the particular entry was a winner, not a winner, or that the sweepstakes or contest has ended once the time period has expired.

A system in accordance with one or more of the above examples, wherein the memory by the at least one computer processor stores the contact information of the user's communications device.

A system in accordance with one or more of the above examples, wherein processor of the distributor queries a 3rd party reverse lookup services based on the unique identifying information of the user's communications device and stores such information returned from the query into the memory by the at least one computer processor.

A system in accordance with one or more of the above examples, wherein the message that is downloaded to the user's communications device can contain a message published to the screen of the user's communications device stating that a sweepstakes or contest entry has been received by the distributor or, if the identification information of the user's communications device has achieved its maximum allowable tokens within the corresponding timeframe developed by the distributor, the message published to the screen of the user's communications device will state that the user has exceeded the number of sweepstakes or contest entries for a particular time period and invite the user to activate the passive entity again after a certain time period has passed.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A passive entity for automatically generating an electronic message related to a promotional item of value, the entity comprising:
information embedded within the passive entity, the information comprising:
message header information comprising a destination address for the electronic message,
message body information comprising an informational message to the consumer, and
a unique identifier code associated with the item of value;
wherein the passive entity is configured to provide the embedded information to an information gathering component of a communication device of a consumer when the communication device interacts with the passive entity; and
wherein the provided embedded information causes an electronic message component of the communication device to automatically generate a prepopulated electronic message having the message header information, the message body information, and the unique identifier code.

2. A passive entity in accordance with claim 1, wherein the unique identifier code in the prepopulated message is prepended with a special character for identifying which portion of the message body comprises the unique identifier code.

3. A passive entity in accordance with claim 1, wherein the passive entity is configured to be presented to a consumer on a promotion associated with the item of value, wherein the promotion comprises one or more of electronic visual media, billboards, signs, and consumer product labels.

4. A passive entity in accordance with claim 1, wherein the unique identifier code is configured to trigger a reply electronic message generated for transmission to the communication device in response to receipt of the prepopulated message from the communication device, the reply message providing information regarding the item of value to the consumer.

5. A passive entity in accordance with claim 1, wherein the passive entity comprises a QR code.

6. A passive entity in accordance with claim 1, wherein the item of value comprises one or more of a good, a service, a coupon related to a good or service, promotional information regarding an item or service, a contest entry, and a reward.

7. A passive entity in accordance with claim 1, wherein the electronic message component is a short message service (SMS) application, and the prepopulated message is a prepopulated SMS message.

8. A system for employing a passive entity to automatically generate an electronic message related to a promotional item of value, the method comprising:
a network-based component configured to associate a unique identifier code with an item of value, and generate a passive entity having information embedded therein, the embedded information comprising:
electronic message header information comprising a destination address for the prepopulated message,
electronic message body information comprising an informational message to the consumer, and
the unique identifier code associated with the item of value;
a database configured to store the unique identifier code and the association of the unique identifier code with the item of value;
a promotion module for providing the passive entity to a consumer, wherein the passive entity is configured to provide the embedded information to an information gathering component of a communication device of a consumer when the communication device interacts with the passive entity, and wherein the provided embedded information causes an electronic message component of the communication device to automatically generate a prepopulated electronic message having the message header information, the message body information, and the unique identifier code;
wherein the network-based component is further configured to:
receive the prepopulated message and extract the unique identifier code from the prepopulated message,
access the database to identify the item of value using the unique identifier code, and
generate and transmit a reply electronic message to the communication device in response to receiving the prepopulated message, the reply message providing information regarding the item of value to the consumer.

9. A system in accordance with claim 8, wherein the unique identifier code in the prepopulated message is prepended with a special character identifying which portion of the message body comprises the unique identifier code.

10. A system in accordance with claim 8, wherein the promotion comprises one or more of electronic visual media, billboards, signs, and consumer product labels.

11. A system in accordance with claim 8, wherein the item of value comprises one or more of a good, a service, a coupon related to a good or service, promotional information regarding an item or service, a contest entry, and a reward.

12. A system in accordance with claim 8, wherein the reply message comprises a hyperlink selectable by the consumer, wherein the hyperlink is associated with one or more of: a website associated with the item of value, contact information of a merchant of the item of value, and contact information of an agent of the merchant of the item of value.

13. A system in accordance with claim 8, wherein the network-based component is further configured to generate and transmit an electronic message to an agent associated with the item of value in response to receiving the prepopulated message from the communication device, the electronic message to the agent comprising identification information associated with the consumer or the communication device of the consumer.

14. A system in accordance with claim 8, wherein the electronic message component is a short message service (SMS) application, and the prepopulated message is a prepopulated SMS message.

15. A method for employing a passive entity to automatically generate an electronic message related to a promotional item of value, the method comprising:
associating a unique identifier code with an item of value;
generating a passive entity having information embedded therein comprising:
electronic message header information comprising a destination address for the prepopulated message,
electronic message body information comprising an informational message to the consumer, and
the unique identifier code associated with the item of value;
storing the unique identifier code and the association of the unique identifier code with the item of value in a database;
presenting the passive entity to the consumer, wherein the passive entity is configured to provide the embedded information to an information gathering component of a communication device of a consumer when the communication device interacts with the passive entity;
wherein in response to a gathering of the information from the passive entity by the information gathering component, the gathered information causes an electronic message component of the communication device to:
activate the electronic message component, and
automatically generate a prepopulated message, wherein a message header and a message body of the prepopulated message are provided by the gathered information, and wherein the message body comprises the unique identifier code;
receiving the prepopulated message and extracting the unique identifier code from the prepopulated message; and
accessing the database to identify the item of value using the unique identifier code; and
generating and transmitting a reply electronic message to the communication device in response to receiving the prepopulated message, the reply message providing information regarding the item of value to the consumer.

16. A method in accordance with claim 15, wherein the unique identifier code in the prepopulated message is prepended with a special character identifying which portion of the message body comprise the unique identifier code.

17. A method in accordance with claim 15, wherein the presenting comprises presenting the passive entity in association with a presenting of the item of value, the presenting comprising using one or more of electronic visual media, billboards, signs, and consumer product labels.

18. A method in accordance with claim 15, wherein the prepopulated message further comprises identification information associated with the consumer or the communication device of the consumer, the method further comprising generating and transmitting, in response to receiving the prepopulated message from the communication device, an electronic message to an agent associated with the item of value, the electronic message to the agent comprising the identification information associated with the consumer or the communication device of the consumer.

19. A method in accordance with claim 15, wherein the item of value comprises one or more of a good, a service, a coupon related to a good or service, promotional information, a contest entry, and a reward.

20. A method in accordance with claim 15, wherein the electronic message component is a short message service (SMS) application, and the prepopulated message is a prepopulated SMS message.
